(19) United States
(12) Patent Application Publication
(10) Pub. No.: US 2025/0096996 A1
(43) Pub. Date: Mar. 20, 2025

(54) FULL DUPLEX TRANSCEIVER WITH IMPEDANCE SENSING

(71) Applicant: QUALCOMM Incorporated, San Diego, CA (US)

(72) Inventors: Maziar HEDAYATI, San Diego, CA (US); Chuan WANG, San Diego, CA (US); Hong-Ming LEE, San Diego, CA (US); Kevin Hsi-Huai WANG, San Diego, CA (US)

(21) Appl. No.: 18/469,972

(22) Filed: Sep. 19, 2023

(51) Int. Cl. H04L 5/14; H04B 1/04; H04B 1/40

(52) U.S. Cl. CPC H04L 5/14; H04B 1/0475; H04B 1/40; H04B 2001/0408

(57) ABSTRACT

A method of controlling a full duplex transceiver of a mobile wireless communication device includes: transmitting a transmit signal from a power amplifier of transmit circuitry of the full duplex transceiver, via a duplexer of the full duplex transceiver, to an antenna of the full duplex transceiver; receiving, via the antenna and the duplexer, a receive signal by receive circuitry of the full duplex transceiver; obtaining at least three voltage measurements from respective points between the power amplifier and the antenna; and providing at least one control signal, within the full duplex transceiver, based on the at least three voltage measurements.

### BACKGROUND

Wireless communication devices are increasingly popular and increasingly complex. For example, mobile telecommunication devices have progressed from simple phones, to smart phones with multiple communication capabilities (e.g., multiple cellular communication protocols, Wi-Fi, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5th generation (5G) of wireless communication technology, mmW (millimeter-wave) phased array antennas have received extensive attention to address the propagation loss and aperture blockage hurdles by introducing higher antenna gain and beamforming features. Multiple-input-multiple-output (MIMO) systems is one of the key enablers of 5G technology to increase the spectral efficiency and system capacity by effectively streaming the transmit/receive data with two orthogonally polarized signals (cross-polarized signals) in desired directions. The trend in consumer electronics is to develop RF (Radio Frequency) assemblies (radio frequency assemblies) with small form factors which can be easily accommodated within the limited space of the emerging smart devices including cell phones and tablets. The physical requirements of antennas make maintaining or improving performance (e.g., in terms of coverage, latency, and quality of service over desired coverage area) difficult.

Duplexers may be used to enable concurrent transmission and reception of wireless signals. For example, an electrical balance duplexer may be used, with performance of the duplexer depending on matching between antenna impedance and balance port impedance. A tracking loop may be used to provide a correction signal to a balance network based on transmission leakage to attempt to restore a hybrid transformer balance.

### SUMMARY

An example mobile wireless communication device includes: an antenna; a duplexer communicatively coupled to the antenna, the transmit circuitry, and the receive circuitry; transmit circuitry, communicatively coupled to the antenna via the duplexer, including a power amplifier and configured to provide a transmit signal for transmission by the antenna; receive circuitry, communicatively coupled to the antenna via the duplexer, configured to process a receive signal received by the antenna; a plurality of sensors communicatively coupled to the antenna and the power amplifier and configured to obtain at least three voltage measurements from respective points between the power amplifier and the antenna; and a controller communicatively coupled to the plurality of sensors and configured to provide at least one control signal based on the at least three voltage measurements.

An example method of controlling a full duplex transceiver of a mobile wireless communication device includes: transmitting a transmit signal from a power amplifier of transmit circuitry of the full duplex transceiver, via a duplexer of the full duplex transceiver, to an antenna of the full duplex transceiver; receiving, via the antenna and the duplexer, a receive signal by receive circuitry of the full duplex transceiver; obtaining at least three voltage measurements from respective points between the power amplifier and the antenna; and providing at least one control signal, within the full duplex transceiver, based on the at least three voltage measurements.

An example full duplex transceiver includes: means for transmitting a transmit signal via a power amplifier and a duplexer to an antenna of the full duplex transceiver; means for receiving, via the antenna and the duplexer, a receive signal; means for obtaining at least three voltage measurements from respective points between the power amplifier and the antenna; and means for providing at least one control signal, within the full duplex transceiver, based on the at least three voltage measurements.

An example non-transitory, processor-readable storage medium includes processor-readable instructions to cause at least one processor, of a full duplex transceiver, to: transmit a transmit signal via a power amplifier and a duplexer to an antenna of the full duplex transceiver; receive, via the antenna and the duplexer, a receive signal; obtain at least three voltage measurements from respective points between the power amplifier and the antenna; and provide at least one control signal, within the full duplex transceiver, based on the at least three voltage measurements.

### BRIEF DESCRIPTION OF THE DRAWINGS

FIG. 1 is a schematic diagram of a communication system.

FIG. 2 is a block diagram of components of a full duplex transceiver.

FIG. 3 is a block diagram of a mobile wireless communication system including a full duplex transceiver.

FIG. 4 is a circuit diagram of an example of the full duplex transceiver shown in FIG. 3.

FIG. 5 is a diagram of circuit components for training a machine-learning model, of a full duplex transceiver, shown in FIG. 4.

FIG. 6 is a table of training data produced using the arrangement shown in FIG. 5.

FIG. 7 is a table of the trained machine-learning model shown in FIG. 4.

FIG. 8 is a representative circuit of a tuner shown in FIG. 4.

FIG. 9 is block flow diagram of a method of controlling a full duplex transceiver of a mobile wireless communication system.

FIG. 10 is a Smith chart showing predicted and targeted impedances.

### DETAILED DESCRIPTION

Techniques are discussed herein for providing a full duplex transceiver that can adapt to different antenna impedances. For example, a full duplex transceiver may adapt to antenna impedance variations due to temperature and/or one or more other environmental conditions such as an antenna housing, presence of an object proximate to an antenna, etc. For example, a model relating three or more voltages to different antenna impedances may be used to adjust an impedance of a balance circuit of a duplexer based on present values of the three or more voltages within a full duplex transceiver. Examples of techniques discussed herein may include sensing voltage at three points and adjusting a mmW transceiver based on voltages at those three points and a corresponding model. In some examples, an antenna tuner may be adjusted. The three points may be at the output of a power amplifier (PA) (e.g., between the PA output and an antenna), but other voltages may be measured from other locations. In some examples, the transceiver is configured for FDD (Frequency Domain Duplex) operation. Other configurations, however, may be used.

Items and/or techniques described herein may provide one or more of the following capabilities, as well as other capabilities not mentioned. A duplexer may adapt to dynamic antenna impedances to maintain isolation between transmit and receive circuits, and may do so in a small form factor typical of mobile communication devices, may do so over a wide bandwidth, and/or may do so at millimeter-wave frequencies. Varying antenna impedances may be sensed such that the varying impedance may be compensated for, even in the absence of an available tuner in a full duplex transceiver. Impedance adjustments for a balance circuit of an electrical balance duplexer may be determined in a way that is not power dependent, and/or without using sensing loops to provide current and voltage injected to an antenna, and/or without requiring phase alignment of voltage and current. Desired isolation between transmission and reception circuitry may be achieved, and a load presented to a transmission power amplifier may be adjusted to help increase (e.g., optimize within manufacturing constraints) saturation power and efficiency. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

The discussion herein focuses on communication systems, and in particular mmW communication systems. The techniques discussed herein, however, may be used for other applications, e.g., other purposes and/or other frequency ranges.

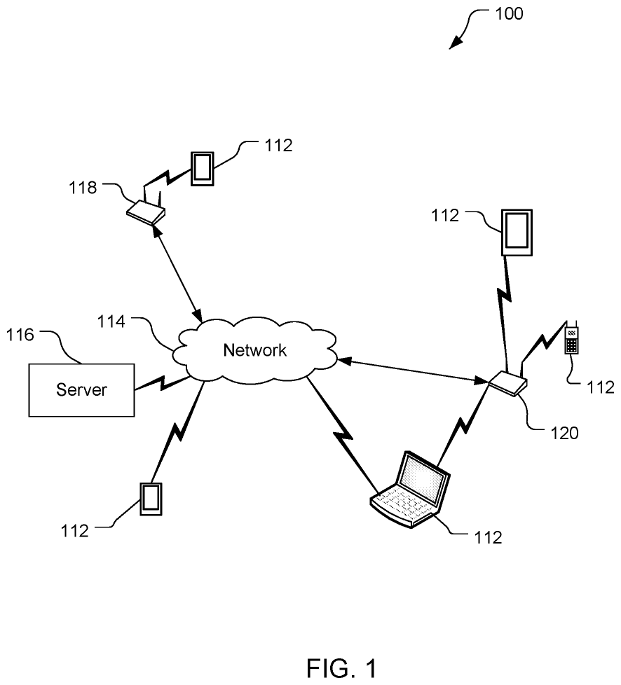

Referring to FIG. 1, a communication system 100 includes mobile devices 112, a network 114, a server 116, and access points (APs) 118, 120. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi communication, multiple frequencies of Wi-Fi communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.). Each of the mobile devices 112 may be referred to as a user equipment (UE), or may be configured as a consumer premises equipment (CPE).

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IoT) device, automobile, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on. Further, two or more UEs may communicate directly in some configurations with or without passing information to each other through a network.

It may be desirable to implement FDD (Frequency Division Duplex) signaling with millimeter-wave (mmwave) signals using one or more devices in the system 100. Conventionally, a surface acoustic wave (SAW) duplexer is used to implement FDD signaling because of the high isolation provided by a SAW duplexer. With an increased number of bands for mmwave signaling, RF front-end complexity will increase significantly. A tunable duplexer may be implemented using a tunable lumped LC or microstrip filter, which may provide transmit-receive (Tx-Rx) isolation up to 20 dB. An electrical balance duplexer (EBD) may be used and provides isolation based on electrical balance between a Tx path and an Rx path to cancel the Tx signal at an Rx input. Implementing an EBD for mmwave signaling may present challenges. For example, performance of the EBD is heavily dependent on matching an impedance presented by an antenna and an impedance of a balance load. As another example, an impedance of a mmwave antenna array may vary for different beam angles and may vary based on an environment of the antenna, e.g., a phone housing, proximity of a user (e.g., a hand of a user) to the antenna, etc. In such a dynamic environment, implementing a balance network that can be tuned to match the antenna impedance in the transmit and receive frequency bands to achieve desired isolation in both bands may be difficult. Also, providing a suitable impedance to a power amplifier (PA) over a wide frequency range such that desired insertion loss is achieved may be difficult.

Techniques are discussed herein to sense an impedance presented by an antenna to a power amplifier. The antenna and power amplifier may be included in a full duplex transceiver. At least three voltages are sensed between the power amplifier and an antenna and the sensed voltages may be used by a model relating the voltages to one or more corresponding impedance adjustments for a balance circuit of the transceiver. The model may determine antenna impedance based on the voltages and/or may determine an impedance of the balance circuit to balance impedances seen by the power amplifier from the antenna and from the balance circuit.

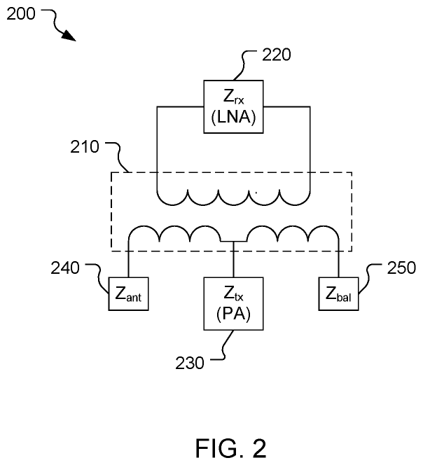

Referring to FIG. 2, a full duplex transceiver 200, e.g., of a mobile wireless communication device (for example, the mobile device 112), includes a duplexer 210, receive circuitry 220, transmit circuitry 230, an antenna 240, and balance circuitry 250.

The receive circuitry 220 includes an LNA (Low-Noise Amplifier) and has a receive circuitry impedance Zᵣₓ. The transmit circuitry 230 includes a PA (Power Amplifier) and has a transmit circuitry impedance Zₜₓ. The duplexer 210 is an EBD with isolation between the transmit circuitry 230 and the receive circuitry 220 depending on a balance between an antenna impedance Zₐₙₜ provided by the antenna 240 and a balance circuit impedance Z_{bal} provided by the balance circuitry 250. The impedances Zₐₙₜ and Z_{bal} may be functions of frequency, and may vary based on temperature, component aging, environment, etc. A reflection coefficient Γₐₙₜ(ω) from the transmit circuitry 230 toward the antenna 240 and a reflection coefficient Γ_{bal}(ω) toward the balance circuitry 250 may be given by

$${Γ}_{ant} ( ω ) = \frac{{Z}_{ant} ( ω ) - {R}_{0}}{{Z}_{ant} ( ω ) + {R}_{0}} \qquad ( 1 )$$

$${Γ}_{bal} ( ω ) = \frac{{Z}_{bal} ( ω ) - {rR}_{0}}{{Z}_{bal} ( ω ) + {rR}_{0}} \qquad ( 2 )$$

where r is a split ratio of PA power between the antenna 240 and the balance circuitry 250, and R₀ is line resistance, e.g., 50 ohms. When Γₐₙₜ(ω)=Γ_{bal}(ω), high isolation between the transmit circuitry 230 and the receive circuitry 220 can be achieved. Even slight deviations from Γₐₙₜ(ω)=Γ_{bal}(ω) may significantly affect isolation. For example, a 2% mismatch between Zₐₙₜ and Z_{bal} may result in a decrease in isolation of about 15 dB relative to equal impedances, and an 8% mismatch between Zₐₙₜ and Z_{bal} may result in a decrease in isolation of about 24 dB. Because Γₐₙₜ(ω) and Γ_{bal}(ω) are frequency and environment (e.g., temperature, nearby objects) dependent, achieving high isolation over a wide bandwidth and/or in different environments is challenging. For example, a housing of the device 200 or a case placed thereon may affect the antenna impedance Zₐₙₜ which may affect a return loss seen by the transmit circuitry 230. Because imbalanced impedances may significantly affect isolation, and thus device performance, having accurate sensing of the antenna impedance Zₐₙₜ may be useful to control the balance circuitry impedance Z_{bal} to achieve impedance balance and thus high isolation between the transmit circuitry 230 and the receive circuitry 220. Accurate sensing of antenna impedance Zₐₙₜ may be useful for other functions as well.

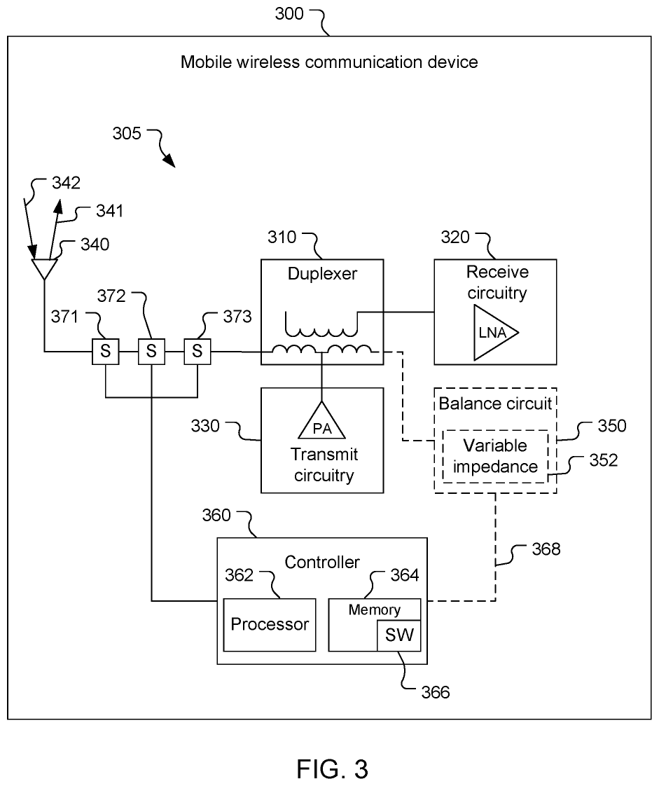

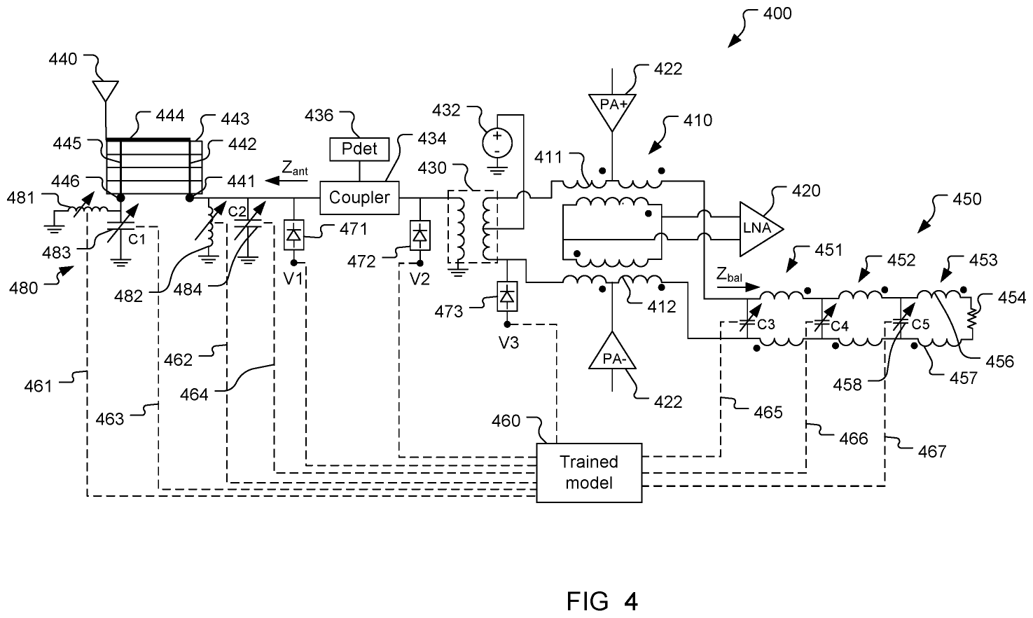

Referring also to FIG. 3, a mobile wireless communication device 300 (e.g., the device 112) includes a full duplex transceiver 305 that includes a duplexer 310, receive circuitry 320, transmit circuitry 330, an antenna 340, a controller 360, sensors 371, 372, 373, and, optionally, balance circuitry 350. The receive circuitry 320, possibly in combination with a processor (e.g., of the controller 360) is configured to receive signals and process, e.g., decode, the received signals. The transmit circuitry 330, possibly in combination with a processor (e.g., of the controller 360) is configured to produce and provide transmission signals to the antenna 440 for wireless transmission. Other components (not illustrated) that facilitate the reception, transmission, and/or processing of signals may be included in the device 300. For example, phase shifters, one or more stages of mixer, filters, baseband and digital processing circuitry, a modem, etc. One or more of the elements illustrated in FIG. 3 may be implemented in combination with an element not illustrated. For example, the controller 360 or a portion thereof (e.g., a processor 362) may be implemented in the modem or a processor associated with the modem. In some examples, all of the elements illustrated in the transceiver 305 are included in a module having multiple components packaged together. In other examples, the controller 360 is omitted from the module. In some examples, all of the elements illustrated in the transceiver 305 except the antenna 340 are included in an integrated circuit, for example a radio frequency integrated circuit (RFIC) which is coupled to a transceiver chip by one or more interconnects. In other examples, the controller 360 is also omitted from the integrated circuit. A tuner (FIG. 4) may also be included in the integrated circuit and/or module.

The receive circuitry 320 is communicatively coupled to the antenna 340 via the duplexer 310. The transmit circuitry is communicatively coupled to the antenna 340 via the duplexer 310. The duplexer 310 is configured to convey signals from the transmit circuitry 330 to the antenna 340 and to convey signals from the antenna 340 to the receive circuitry 320 while providing isolation between the receive circuitry 320 and the transmit circuitry 330. The antenna 340 is configured to transduce a guided transmit signal (e.g., an electrical or optical signal) into a wireless transmit signal 341 and to transduce a wireless receive signal 342 into a guided receive signal. The sensors 371-373 are communicatively coupled to the controller 360 and configured to measure respective voltages between the duplexer 310 and the antenna 340. The controller 360 is configured to produce one or more control signals 368 based on the voltages sensed by the sensors 371-373. For example, the balance circuit 350 may include a variable impedance 352 to provide a variable balance circuit impedance, and the control signal(s) 368 may be provided by the controller 360 to the balance circuit 350 to control an impedance of the variable impedance 352. The impedance of the variable impedance 352 may be selected, e.g., to attempt to have the impedance of the variable impedance 352 match an impedance of the antenna 340 seen by the transmit circuitry 330, e.g., by a power amplifier of the transmit circuitry 330. While the three sensors 371-373 are shown in the device 300, a different quantity of sensors, e.g., more than three sensors, may be used.

The controller 360 may include the processor 362 and memory 364 (which may store software 366). The processor 362 may include one or more hardware devices, e.g., a central processing unit (CPU), a microcontroller, an application specific integrated circuit (ASIC), etc. The processor 362 may comprise multiple processors including a general-purpose/application processor and/or a Digital Signal Processor (DSP), and may include one or more specialty processors, e.g., a sensor processor and/or a modem processor. One or more of such processors may comprise multiple devices (e.g., multiple processors). For example, a sensor processor may comprise, e.g., one or more voltage processors and/or one or more processors for RF (radio frequency) signal measurement and/or decoding. A modem processor may support dual SIM/dual connectivity (or even more SIMs). The memory 364 may be a non-transitory storage medium that may include random access memory (RAM), flash memory, disc memory, and/or read-only memory (ROM), etc. The memory 364 may store the software 366 which may be processor-readable, processor-executable software code containing instructions that may be configured to, when executed, cause the processor 362 to perform various functions described herein. Alternatively, the software 366 may not be directly executable by the processor 362 but may be configured to cause the processor 362, e.g., when compiled and executed, to perform the functions. The description herein may refer to the processor 362 performing a function, but this includes other implementations such as where the processor 362 executes software and/or firmware. The processor 362 may include a memory with stored instructions in addition to and/or instead of the memory 364. Functionality of the processor 362 is discussed more fully below.

Referring also to FIG. 4, a full duplex transceiver 400, e.g., of a wireless communication device, may be an example of the transceiver 305 shown in FIG. 3. The transceiver 400 includes a duplexer 410, receive circuitry including an LNA 420, transmit circuitry including a power amplifier 422, a balun 430, a bias source 432, a coupler 434, a power detector 436, an antenna 440, a balance circuit 450, a trained model 460, voltage sensors 471, 472, 473, and a tuner 480. The transceiver 400 is an example, and other transceiver configurations may be used. For example, a transceiver may include more sensors than the three voltage sensors 471-473 shown. Also or alternatively, a balance circuit configuration may be used that is different than the configuration of the balance circuit 450. Also or alternatively, a tuner configuration may be used that is different than the configuration of the tuner 480. As another example, a transceiver may not include a tuner for an antenna. For example, the tuner 480 may be omitted from a full duplex transceiver.

The duplexer 410 is an EBD and is communicatively coupled to the LNA 420, the PA 422, the antenna 440 (via, among other things, the balun 430 and the coupler 434), and the balance circuit 450. The duplexer 410 includes split coils 411, 412 each fed by a respective polarity of the PA 422, e.g., center-tapped by respective connections to a positive line and a negative line from the PA 422. The LNA 420 is coupled to the duplexer 410 to receive signals received from the antenna 440. In other examples, one or both of the LNA 420 and the PA 422 are configured to be coupled to the duplexer 410 via a single-ended connection. For example, an input of the LNA 420 may be coupled by a single connection to the duplexer 410 and/or an output of the PA 422 may be coupled by a single connection to the duplexer 410.

The balun 430 is configured to convert a balanced transmission line from the duplexer 410 to an unbalanced transmission line to the antenna 440. The bias source 432 provides a bias voltage to one side (one coil) of the balun 430.

The coupler 434 is configured to divert some energy received by the coupler 434 (from the PA 422 or from the antenna 440) and provide the diverted energy to a power detector 436. The power detector 436 is configured to determine the power of a signal received by the coupler 434 and provide an indication of the determined power. The power detector 436 may use values of voltages V1, V2 (discussed further herein), e.g., on opposite ends of the coupler 434, to determine the power and operational status of the PA 422. In some examples, the duplexer 410 is configured to directly couple to the coupler 434 via a single-ended connection, and the balun 430 (and bias source 432) is omitted.

The coupler 434 is communicatively coupled to the antenna 440, for example via the tuner 480 in the illustrated configuration, and in particular via a bump 441 (e.g., a solder ball or solder pad). The antenna 440 may be formed on a PCB 443 (Printed Circuit Board), and coupled to the bump 441 by a transmission line 442 (e.g., formed by a series of vias) through layers of the PCB 443, and a transmission line 444. The transmission line 444 may also be connected through another transmission line 445 (e.g., formed by a series of vias) to another bump 446. The bumps 441, 446, and the transmission lines 442, 444, 445 may form portions of the tuner 480, with the tuner being communicatively coupled to the antenna 440 and the trained model 460, e.g., the controller 360. In some examples, the bump 446 is connected to a transceiver chain that is configured to operate with signals that are a different frequency than the signals in the transceiver 400. For example, the transceiver 400 may be configured to operate in a low mmw band and the transceiver coupled to the bump 446 may be configured to operation in a high mmw frequency band. The low and high frequency bands may be, for example, FR2-1 (24.25 GHZ-52.6 GHZ) and FR2-2 (52.6 GHZ-71 GHZ) or 24 GHz-30 GHz and 37 GHz-44 (or 48) GHz, respectively. In some such examples, the bumps 441, 446 are coupled to the same antenna stack, but to different physical conductors in the antenna 440. In other examples, the bump 446 is not connected to another transceiver chain.

The tuner 480 may couple the bumps 441, 446 to ground via respective reactive components. For example, as shown, the bump 446 may be connected to ground via an inductor 481 and via a capacitor 483. In this example, the inductor 481 is a variable-inductance inductor and the capacitor 483 is a variable-capacitance capacitor (a varactor). Other configurations, however, may be used, e.g., with the inductor 481 being a fixed-inductance inductor. Also as shown, the bump 441 may be connected to ground via an inductor 482 and via a capacitor 484. In this example, the inductor 482 is a variable-inductance inductor and the capacitor 484 is a variable-capacitance capacitor (a varactor). Other configurations, however, may be used, e.g., with the inductor 482 being a fixed-inductance inductor. Variable reactances of the tuner 480, e.g., of one or more of the inductors 481, 482 and/or of one or more of the capacitors 483, 484, may be controlled by the trained model 460, e.g., a trained model implemented by the controller 360 as discussed further herein. Components to the left (as shown in FIG. 4) of the sensor 471 (here, the antenna 440, the tuner 480, the transmission line 444, the transmission lines 442, 445, and the bumps 441, 446) provide an antenna impedance Zₐₙₜ, which is related to and corresponds to an impedance presented to the PA 422 by components between the PA 422 and the antenna 440.

The balance circuit 450 is configured to provide a variable balance impedance Z_{bal} and in this example includes a chain of LC circuits 451, 452, 453 and a resistor 454. Each of the LC circuits 451-453 includes a pair of inductors 456, 457 and a variable capacitor 458 being connected between the inductors 456, 457, and with the LC circuits 451-453 being connected to each other as shown in parallel. The end LC circuit, here the LC circuit 453 is connected in parallel with the resistor 454. Other configurations of the balance circuit 450 may be used, e.g., with a different quantity of LC circuits, and/or a different LC circuit configuration, and/or different LC circuits in the same balance circuit having different configurations, one or more LC circuits having a fixed-capacitance capacitor instead of a variable-capacitance capacitor, etc. The balance impedance Z_{bal} may be controlled by the trained model 460, e.g., by having values of one or more variable capacitors selected to yield a desired value of the balance impedance Z_{bal}, e.g., as discussed further herein.

The voltage sensors 471-473 are configured to sense voltages at respective locations of circuitry between the PA 422 and the antenna 440. Here, for example, the sensor 471 is connected to measure a voltage V1 between the coupler and the bump 441 (thus between the coupler 434 and a connection to the PCB 443 (which may include the antenna 440)). The sensor 472 in this example is connected to measure a voltage V2 between the balun 430 and the antenna 440, here between the balun 430 and the coupler 434. The sensor 473 in this example is connected to measure a voltage V3 between the duplexer 410 (and thus between the PA 422) and the balun 430. The sensors 471-473 are configured to measure respective voltages and are configured and communicatively coupled to the trained model 460 (e.g., the controller 360) to provide indications of the measured voltages to the trained model 460. The indications of the measured voltages may be amplitudes of the measured voltages without phase information. In some examples, information from the PDET 436 may be used by the trained model 460 in addition to or instead of a sensed voltage from one of the sensors 471-473. For example, one or more of the sensors 471-473, e.g., the sensor 472 or 473 when the balun 430 is omitted, may be omitted and the PDET 436 used instead. In other examples, one or more of the sensors 471-473 are replaced with a respective PDET.

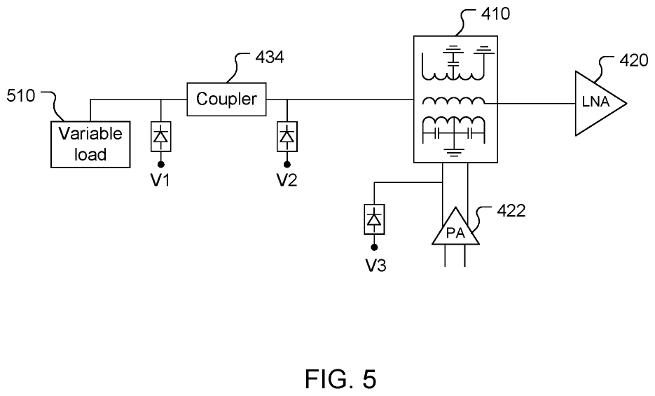

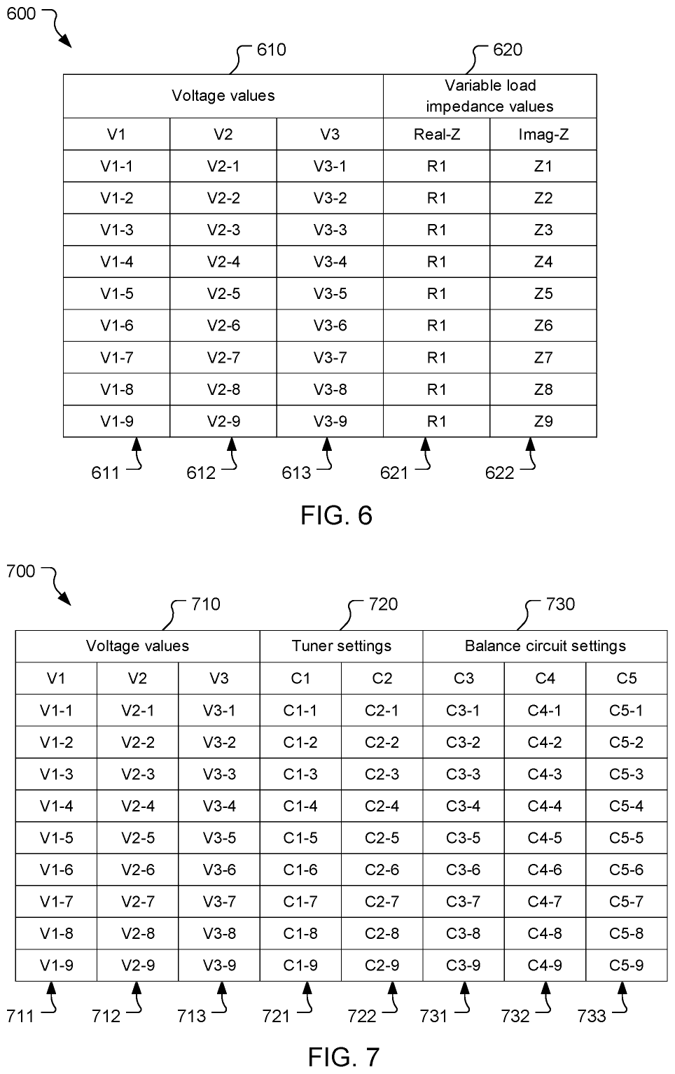

Referring also to FIGS. 5-7, the trained model 460 may be trained and configured to send one or more control signals 461, 462, 463, 464 to the tuner 480 to adjust the tuner 480 to adjust the antenna impedance Zₐₙₜ. For example, the control signal(s) 461-464 may be configured to try to provide an optimum load to the PA 422 such that an impedance seen by the PA 422 toward the antenna 440 matches an impedance of the PA 422. For example, during manufacture or design of the transceiver 400, a variable load 510 may be connected to the coupler 434. An impedance of the variable load 510 may be changed and the voltages V1, V2, V3 sensed for different impedance values of the variable load 510. This may yield a table 600 of training data comprising voltage values 610, here voltage values 611, 612, 613, and variable load impedance values 620, e.g., real impedance component values 621 and corresponding imaginary impedance component values 622 of the variable load 510. The voltage values 610 and the impedance values 620 may be used to train a machine learning model resulting in the trained model 460. It has been found that the trained model 460, trained in this way, can predict both inductive and capacitive impedances well. The trained model 460 may comprise, for example, a random forest regressor model. A table 700 represents an example of the trained model 460, with voltage values 710 (e.g., sets of voltage values 711, 712, 713) corresponding to one or more tuner adjustment settings 720, e.g., one or more impedance settings such as reactance settings such as, here, inductance settings 721, 722 corresponding to the inductors 481, 482 and capacitance settings corresponding to the capacitors 483, 484. The table 700 is representative of the trained model 460. A table may or may not be generated and/or stored.

Also or alternatively, the trained model 460 may be trained and configured to send one or more control signals 465, 466, 467 to the balance circuit 450 to adjust, based on measured voltages, the balance circuit 450 to adjust the balance impedance Z_{bal}, e.g., to try to match the balance impedance Z_{bal} and the antenna impedance Zₐₙₜ. For example, the table 700 may include one or more balance impedance settings corresponding to respective sets of the voltage values 710. Here, for example, sets of the voltage values 710 may correspond to one or more balance circuit settings 730, e.g., one or more impedance settings such as reactance settings such as, here, capacitance settings 731, 732, 733 corresponding to the capacitors 458 of the respective LC circuits 451-453. The trained model 460 may or may not know the antenna impedance Zₐₙₜ, and may or may not know the balance impedance Z_{bal} corresponding to the balance circuit settings 730.

The trained model 460 may account for aging of components of the transceiver 400 and/or may account for one or more environmental conditions. For example, the trained model 460 may have different voltage values (and corresponding tuner settings and/or balance circuit settings) for different parameters (e.g., different ages of the transceiver and/or one or more environmental condition values (e.g., temperature, humidity, etc.)). For example, different tables, e.g., like the table 700, may correspond to different values of one or more parameters or a table like the table 700 may include one or more parameter values corresponding to the different sets of voltage values. These tables and/or the values therein may be generated a priori, or may be developed over time, for example pursuant to the machine learning operating while the device is used in different scenarios.

The controller 360, implementing the trained model 460, may adjust the balance impedance Z_{bal} alone (e.g., if an antenna tuner is not included in a transceiver), or both the balance impedance Z_{bal} and the antenna impedance Zₐₙₜ. For example, the controller 360 may adjust the balance impedance Z_{bal} and the antenna impedance Zₐₙₜ concurrently. As another example, the controller 360 may adjust the antenna impedance Zₐₙₜ, then receive new voltage values from the sensors 471-473, then use the new voltage values to adjust the balance impedance Z_{bal} (and possibly further adjust the antenna impedance Zₐₙₜ by adjusting the reactance value(s) of one or more components of the tuner 480). The controller 360 may not explicitly determine the antenna impedance Zₐₙₜ or the balance impedance Z_{bal} or know the impedance of the tuner 480. The controller 360 may implicitly set the tuner impedance and the balance impedance Z_{bal} by selecting the appropriate tuner settings 720 (if a tuner is used) and the appropriate balance circuit settings 730. For example, if the antenna impedance Zₐₙₜ has a value of 17−j19 but a value of 8+j7 is desired, the controller 360 may be unaware of either of these values, but may select tuner settings 720 (and control the tuner 480 accordingly) based on voltage values 710 to attempt to adjust the antenna impedance Zₐₙₜ to a value of 17−j19, and select the balance circuit settings 730 (and control the balance circuit 450 accordingly) to try to follow the antenna impedance Zₐₙₜ.

The same trained model 460 may be used for transmit chains (e.g., for different antennas and/or different antenna elements (e.g., for a phased array)). While impedances of different antennas or antenna elements may be different, the same trained model 460 may be used as long as the trained model 460 can provide tuning and/or balance circuit adjustments corresponding to the different impedances. In other examples, a separate trained model is used for each of a plurality of transmit and/or receive chains (e.g., in a phased array), for example when the conditions at different antennas or chains necessitate different tuning and/or balance circuit adjustments.

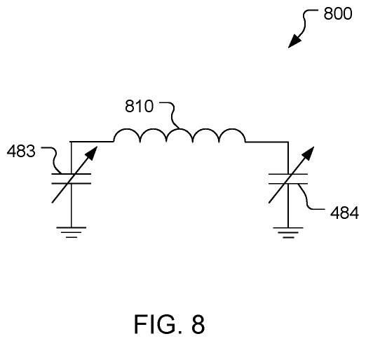

Referring also to FIG. 8, the tuner 480 may be modeled as a π circuit 800. The transmission lines 442, 444, 445 may provide a high-Q inductance represented by an inductor 810. Parasitic capacitances of the bumps 441, 446 may be absorbed by inductances of the inductors 481, 482, and thus are not shown, leaving the variable capacitors 483, 484. Without the inductors 481, 482, the parasitic capacitances may overwhelm the capacitances of the variable capacitors 483, 484 such that the variable capacitors 483, 484 may not be able to effectively alter the antenna impedance Zₐₙₜ enough to provide a desired impedance to the PA 422 (e.g., an impedance matching an impedance of the power amplifier 422). The inductor 482 may be merged with a triple coil of the PA 422, which may help keep a form factor of the transceiver 400 small, and without changing current distribution for the antenna 440, without inducing pattern squint, and without increasing cross polarization. The value of the inductor 810 may vary with different lengths of the transmission line 444 for different antennas of a device, e.g., a wireless communication device. For example, depending on antenna layout on a PCB, the transmission line 444 connecting the bumps 441, 446 for different antennas may have different lengths, and different corresponding inductance values.

It has been found through computer simulations that use of the tuner 480 may significantly improve transceiver performance. For example, simulations of a transceiver that included the tuner 480 had return losses between 8 dB and 18.4 dB lower than a similar transceiver without the tuner 480. The simulations showed that use of the tuner 480 could even improve insertion loss at some frequencies. Also, better output power was achieved for full duplex transceivers using an antenna tuner compared to transceivers without an antenna tuner.

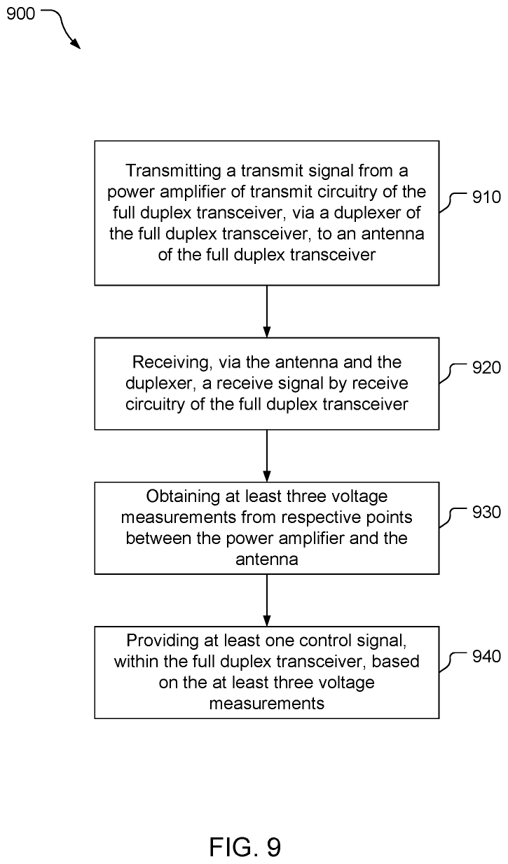

Referring to FIG. 9, with further reference to FIGS. 1-8, a method 900 of controlling a full duplex transceiver of a mobile wireless communication device includes the stages shown. The method 900 is, however, an example only and not limiting. The method 900 may be altered, e.g., by having one or more stages added, removed, rearranged, combined, performed concurrently, and/or by having one or more single stages split into multiple stages.

At stage 910, the method 900 includes transmitting a transmit signal from a power amplifier of transmit circuitry of the full duplex transceiver, via a duplexer of the full duplex transceiver, to an antenna of the full duplex transceiver. For example, the transmit circuitry 330 (which may include a processor and memory such as a portion of the processor 362 and a portion of the memory 364) transmits a signal via a PA of the transmit circuitry and via the duplexer 310 to the antenna 340. The antenna 340 may transmit the signal as the transmit signal 341. The transmit circuitry 330, possibly including a processor and/or memory (e.g., a portion of the processor 362 and/or a portion of the memory 364), may comprise means for transmitting the transmit signal. As another example, transmit circuitry may transmit a signal via the PA 422, the duplexer 410, the balun 430, the coupler 434, and the transmission lines 442, 444 to the antenna 440, and the transmit circuitry, the balun 430, the coupler 434, and the transmission lines 442, 444 may comprise means for transmitting the transmit signal.

At stage 920, the method 900 includes receiving, via the antenna and the duplexer, a receive signal by receive circuitry of the full duplex transceiver. For example, the receive signal 342 may be received by the receive circuitry 320 (which may include a processor and memory such as a portion of the processor 362 and a portion of the memory 364) via the antenna 340 and the duplexer 310. The receive circuitry 320, possibly including a processor and/or memory (e.g., a portion of the processor 362 and/or a portion of the memory 364), may comprise means for receiving the receive signal. As another example, receive circuitry may receive a signal via the antenna 440, the transmission lines 442, 444, the coupler 434, the balun 430, and the duplexer 410, and the transmission lines 442, 444, the coupler 434, the balun 430, and the receive circuitry (e.g., the LNA 420 and possibly a portion of the processor 362 and/or a portion of the memory 364) may comprise means for receiving the receive signal.

At stage 930, the method 900 includes obtaining at least three voltage measurements from respective points between the power amplifier and the antenna. For example, the sensors 371-373 may measure voltages at respective points in the transceiver 305, e.g., respective points in circuitry connecting the transmit circuitry 330 to the antenna 340. The sensors 371-373 may provide indications of voltage measurements to the controller 360. The sensors 371-373, possibly in combination with the controller 360 (e.g., the processor 362 and the memory 364) may comprise means for obtaining at least three voltage measurements. As another example, the sensors 471-473 (and/or the PDET 436), possibly in combination with the trained model 460 (e.g., implemented by the processor 362 and the memory 364) may comprise means for obtaining at least three voltage measurements.

At stage 940, the method 900 includes providing at least one control signal, within the full duplex transceiver, based on the at least three voltage measurements. For example, the controller 360 may provide the control signal(s) 366 (e.g., in accordance with one or more of the balance circuit settings 730 corresponding to a set of the voltage values 710 corresponding to the voltage measurements) to the balance circuit 350 to set the impedance of the variable impedance 352. The controller 360, e.g., the processor 362 in combination with the memory 364, may comprise means for providing at least one control signal. As another example, the trained model 460 may provide the control signal(s) 461-464 (e.g., in accordance with one or more of the tuner settings 720 corresponding to a set of the voltage values 710 corresponding to the voltage measurements) to the tuner 480 to set an impedance of the tuner 480 and/or may provide the control signal(s) 465-467 to the balance circuit 450 to set an impedance of the balance circuit 450. The trained model 460 (e.g., the processor 362 in combination with the memory 364) may comprise means for providing at least one control signal. Control signals for other elements may additionally or alternatively be provided, for example to adjust a value of one or more capacitances (not illustrated) which are connected across respective coils in the duplexer 410.

Implementations of the method 900 may include one or more of the following features. In an example implementation, providing the at least one control signal comprises providing a balance circuit impedance control signal to a balance circuit, of the full duplex transceiver and having a variable balance circuit impedance, to control a value of the variable balance circuit impedance. For example, the trained model 460 may provide one or more of the control signal(s) 465-467 to the balance circuit 450 to set one or more capacitance values of one or more corresponding variable capacitors of one or more of the LC circuits 451-453 to set an impedance of the balance circuit 450. In a further example implementation, the balance circuit impedance control signal is configured to control the value of the variable balance circuit impedance to attempt to match a second impedance, presented to the power amplifier by at least the balance circuit, to a first impedance presented to the power amplifier by at least the antenna. For example, the trained model 460 may transmit one or more of the control signal(s) 465-467 to try to make the balance impedance Z_{bal} match the antenna impedance Zₐₙₜ.

Also or alternatively, implementations of the method 900 may include one or more of the following features. In an example implementation, providing the at least one control signal comprises providing a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier. For example, the trained model 460 may provide one or more of the control signal(s) 461-464 to the tuner 480 to set one or more reactance values of one or more of the inductors 481, 482 and/or one or more of the capacitors 483, 484 to set an impedance of the tuner 480 to try to provide an optimum load to the PA 422. In another example implementation, obtaining the at least three voltage measurements comprises obtaining a first voltage measurement from a first point between the power amplifier and a balun of the full duplex transceiver. For example, the sensor 473 may be disposed to measure a voltage at a point between the duplexer 410 and the balun 430. In a further example implementation, obtaining the at least three voltage measurements comprises obtaining a second voltage measurement from a second point between the balun and the antenna. For example, the sensor 471 and/or the sensor 472 may be disposed to measure a respective voltage at a respective point between the balun 430 and the antenna 440, here between the coupler 434 and the antenna 440 or between the balun 430 and the coupler 434, respectively.

Also or alternatively, implementations of the method 900 may include one or more of the following features. In an example implementation, the method 900 includes using a machine learning model to determine an output impedance presented to the power amplifier by circuitry between an output of the power amplifier to, and including, the antenna. For example, the trained model 460 may determine the antenna impedance Zₐₙₜ by finding the variable load impedance values 620 corresponding to a set of the voltage values 610 corresponding to (e.g., matching, or being a closest match to) the measured voltages. The controller 360 (e.g., the processor 362 and the memory 364) may comprise means for using a machine learning model to determine the output impedance.

At least three voltage measurements from a transceiver (e.g., transmit) chain, for example from respective points between the power amplifier and the antenna and/or an impedance determined therefrom, may be used for functions other than those described above. For example, such measurements and/or impedance may be used to determine when one or more antennas are blocked or how a user is holding a mobile wireless communication device. Such information may be used to determine which antenna(s) to use for transmission and/or which antenna(s) to use for reception, for example for efficiency of communications or to comply with exposure requirements, and/or may be used to adjust transmission power levels (e.g., to comply with exposure requirements). Such information may also be used to determine input gestures or an environmental context, etc. In such examples, the mobile communications device may not be full duplex.

### Simulation Results

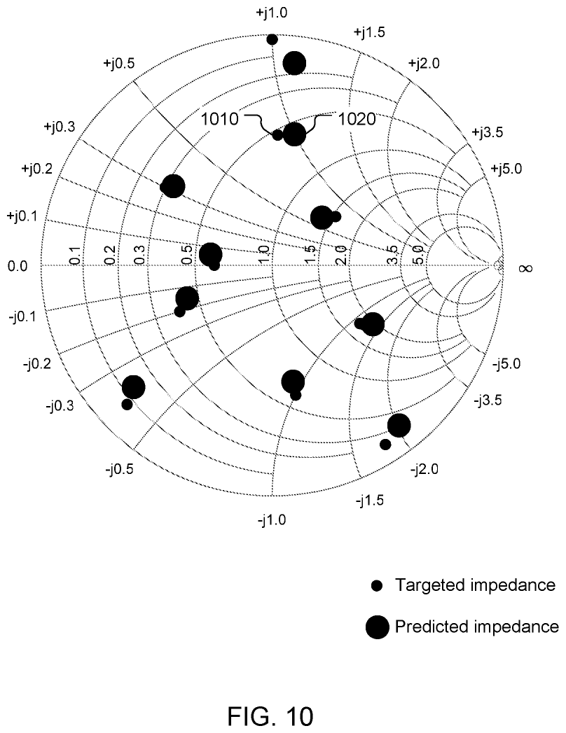

Referring to FIG. 10, with further reference to FIG. 4, the trained model 460 has been shown to predict both inductive and capacitive impedances well. As shown, predicted impedances 1010 determined by the model 460 were close to respective targeted impedances 1020.

### Implementation Examples

Implementation examples are provided in the following numbered clauses.

Clause 1. A mobile wireless communication device comprising:
an antenna;
a duplexer communicatively coupled to the antenna;
transmit circuitry, communicatively coupled to the antenna via the duplexer, including a power amplifier and configured to provide a transmit signal for transmission by the antenna;
receive circuitry, communicatively coupled to the antenna via the duplexer, configured to process a receive signal received by the antenna;
a plurality of sensors communicatively coupled to the antenna and the power amplifier and configured to obtain at least three voltage measurements from respective points between the power amplifier and the antenna; and
a controller communicatively coupled to the plurality of sensors and configured to provide at least one control signal based on the at least three voltage measurements.

Clause 2. The mobile wireless communication device of clause 1, further comprising a balance circuit communicatively coupled to the duplexer and the controller, the balance circuit being configured to provide a variable balance circuit impedance, and wherein to provide the at least one control signal the controller is configured to provide a balance circuit impedance control signal to the balance circuit to control a value of the variable balance circuit impedance.

Clause 3. The mobile wireless communication device of clause 2, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

Clause 4. The mobile wireless communication device of any of clauses 1-3, further comprising a tuner circuit communicatively coupled to the antenna and to the controller and having a variable tuner impedance, and wherein to provide the at least one control signal the controller is configured to provide a tuner control signal to the tuner circuit to set a value of the variable tuner impedance to attempt to cause an output impedance, presented to the power amplifier by at least the antenna and the tuner circuit, to match a power amplifier impedance of the power amplifier.

Clause 5. The mobile wireless communication device of any of clauses 1-4, further comprising a balun communicatively coupled to the antenna and the duplexer between the antenna and the duplexer, wherein a first sensor of the plurality of sensors is configured to obtain a first voltage measurement, of the at least three voltage measurements, from a first point between the power amplifier and the balun.

Clause 6. The mobile wireless communication device of clause 5, wherein a second sensor of the plurality of sensors is configured to obtain a second voltage measurement, of the at least three voltage measurements, from a second point between the balun and the antenna.

Clause 7. The mobile wireless communication device of any of clauses 1-6, wherein the controller is configured to implement a machine learning model to determine an output impedance presented to the power amplifier by circuitry between an output of the power amplifier to, and including, the antenna.

Clause 8. A method of controlling a full duplex transceiver of a mobile wireless communication device, the method comprising:
transmitting a transmit signal from a power amplifier of transmit circuitry of the full duplex transceiver, via a duplexer of the full duplex transceiver, to an antenna of the full duplex transceiver;
receiving, via the antenna and the duplexer, a receive signal by receive circuitry of the full duplex transceiver;
obtaining at least three voltage measurements from respective points between the power amplifier and the antenna; and
providing at least one control signal, within the full duplex transceiver, based on the at least three voltage measurements.

Clause 9. The method of clause 8, wherein providing the at least one control signal comprises providing a balance circuit impedance control signal to a balance circuit, of the full duplex transceiver and having a variable balance circuit impedance, to control a value of the variable balance circuit impedance.

Clause 10. The method of clause 9, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

Clause 11. The method of any of clauses 8-10, wherein providing the at least one control signal comprises providing a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

Clause 12. The method of any of clauses 8-11, wherein obtaining the at least three voltage measurements comprises obtaining a first voltage measurement from a first point between the power amplifier and a balun of the full duplex transceiver.

Clause 13. The method of clause 12, wherein obtaining the at least three voltage measurements comprises obtaining a second voltage measurement from a second point between the balun and the antenna.

Clause 14. The method of any of clauses 8-13, further comprising using a machine learning model to determine an output impedance presented to the power amplifier by circuitry between an output of the power amplifier to, and including, the antenna.

Clause 15. A full duplex transceiver comprising:
means for transmitting a transmit signal via a power amplifier and a duplexer to an antenna of the full duplex transceiver;
means for receiving, via the antenna and the duplexer, a receive signal;
means for obtaining at least three voltage measurements from respective points between the power amplifier and the antenna; and
means for providing at least one control signal, within the full duplex transceiver, based on the at least three voltage measurements.

Clause 16. The full duplex transceiver of clause 15, wherein the means for providing the at least one control signal comprise means for providing a balance circuit impedance control signal to a balance circuit, of the full duplex transceiver and having a variable balance circuit impedance, to control a value of the variable balance circuit impedance.

Clause 17. The full duplex transceiver of clause 16, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

Clause 18. The full duplex transceiver of any of clauses 15-17, wherein the means for providing the at least one control signal comprise means for providing a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

Clause 19. The full duplex transceiver of any of clauses 15-18, wherein the means for obtaining the at least three voltage measurements comprise means for obtaining a first voltage measurement from a first point between the power amplifier and a balun of the full duplex transceiver.

Clause 20. The full duplex transceiver of clause 19, wherein the means for obtaining the at least three voltage measurements comprise means for obtaining a second voltage measurement from a second point between the balun and the antenna.

Clause 21. The full duplex transceiver of any of clauses 15-20, further comprising means for using a machine learning model to determine an output impedance presented to the power amplifier by circuitry between an output of the power amplifier to, and including, the antenna.

Clause 22. A non-transitory, processor-readable storage medium comprising processor-readable instructions to cause at least one processor, of a full duplex transceiver, to:
transmit a transmit signal via a power amplifier and a duplexer to an antenna of the full duplex transceiver;
receive, via the antenna and the duplexer, a receive signal;
obtain at least three voltage measurements from respective points between the power amplifier and the antenna; and
provide at least one control signal, within the full duplex transceiver, based on the at least three voltage measurements.

Clause 23. The non-transitory, processor-readable storage medium of clause 22, wherein the processor-readable instructions to cause the at least one processor to provide the at least one control signal comprise processor-readable instructions to cause the at least one processor to provide a balance circuit impedance control signal to a balance circuit, of the full duplex transceiver and having a variable balance circuit impedance, to control a value of the variable balance circuit impedance.

Clause 24. The non-transitory, processor-readable storage medium of clause 23, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

Clause 25. The non-transitory, processor-readable storage medium of any of clauses 22-24, wherein the processor-readable instructions to cause the at least one processor to provide the at least one control signal comprise processor-readable instructions to cause the at least one processor to provide a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

Clause 26. The non-transitory, processor-readable storage medium of any of clauses 22-25, wherein the processor-readable instructions to cause the at least one processor to obtain the at least three voltage measurements comprise processor-readable instructions to cause the at least one processor to obtain a first voltage measurement from a first point between the power amplifier and a balun of the full duplex transceiver.

Clause 27. The non-transitory, processor-readable storage medium of clause 26, wherein the processor-readable instructions to cause the at least one processor to obtain the at least three voltage measurements comprise processor-readable instructions to cause the at least one processor to obtain a second voltage measurement from a second point between the balun and the antenna.

Clause 28. The non-transitory, processor-readable storage medium of any of clauses 22-27, further comprising processor-readable instructions to cause the at least one processor to use a machine learning model to determine an output impedance presented to the power amplifier by circuitry between an output of the power amplifier to, and including, the antenna.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A mobile wireless communication device comprising:
an antenna;
a duplexer communicatively coupled to the antenna;
transmit circuitry, communicatively coupled to the antenna via the duplexer, including a power amplifier and configured to provide a transmit signal for transmission by the antenna;
receive circuitry, communicatively coupled to the antenna via the duplexer, configured to process a receive signal received by the antenna;
a plurality of sensors communicatively coupled to the antenna and the power amplifier and configured to obtain at least three voltage measurements from respective points between the power amplifier and the antenna; and
a controller communicatively coupled to the plurality of sensors and configured to provide at least one control signal based on the at least three voltage measurements.

2. The mobile wireless communication device of claim 1, further comprising a balance circuit communicatively coupled to the duplexer and the controller, the balance circuit being configured to provide a variable balance circuit impedance, and wherein to provide the at least one control signal the controller is configured to provide a balance circuit impedance control signal to the balance circuit to control a value of the variable balance circuit impedance.

3. The mobile wireless communication device of claim 2, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

4. The mobile wireless communication device of claim 1, further comprising a tuner circuit communicatively coupled to the antenna and to the controller and having a variable tuner impedance, and wherein to provide the at least one control signal the controller is configured to provide a tuner control signal to the tuner circuit to set a value of the variable tuner impedance to attempt to cause an output impedance, presented to the power amplifier by at least the antenna and the tuner circuit, to match a power amplifier impedance of the power amplifier.

5. The mobile wireless communication device of claim 1, further comprising a balun communicatively coupled to the antenna and the duplexer between the antenna and the duplexer, wherein a first sensor of the plurality of sensors is configured to obtain a first voltage measurement, of the at least three voltage measurements, from a first point between the power amplifier and the balun.

6. The mobile wireless communication device of claim 5, wherein a second sensor of the plurality of sensors is configured to obtain a second voltage measurement, of the at least three voltage measurements, from a second point between the balun and the antenna.

7. The mobile wireless communication device of claim 1, wherein the controller is configured to implement a machine learning model to determine an output impedance presented to the power amplifier by circuitry between an output of the power amplifier to, and including, the antenna.

8. A method of controlling a full duplex transceiver of a mobile wireless communication device, the method comprising:
transmitting a transmit signal from a power amplifier of transmit circuitry of the full duplex transceiver, via a duplexer of the full duplex transceiver, to an antenna of the full duplex transceiver;
receiving, via the antenna and the duplexer, a receive signal by receive circuitry of the full duplex transceiver;
obtaining at least three voltage measurements from respective points between the power amplifier and the antenna; and
providing at least one control signal, within the full duplex transceiver, based on the at least three voltage measurements.

9. The method of claim 8, wherein providing the at least one control signal comprises providing a balance circuit impedance control signal to a balance circuit, of the full duplex transceiver and having a variable balance circuit impedance, to control a value of the variable balance circuit impedance.

10. The method of claim 9, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

11. The method of claim 8, wherein providing the at least one control signal comprises providing a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

12. The method of claim 8, wherein obtaining the at least three voltage measurements comprises obtaining a first voltage measurement from a first point between the power amplifier and a balun of the full duplex transceiver.

13. The method of claim 12, wherein obtaining the at least three voltage measurements comprises obtaining a second voltage measurement from a second point between the balun and the antenna.

14. The method of claim 8, further comprising using a machine learning model to determine an output impedance presented to the power amplifier by circuitry between an output of the power amplifier to, and including, the antenna.

15. A full duplex transceiver comprising:
means for transmitting a transmit signal via a power amplifier and a duplexer to an antenna of the full duplex transceiver;
means for receiving, via the antenna and the duplexer, a receive signal;
means for obtaining at least three voltage measurements from respective points between the power amplifier and the antenna; and
means for providing at least one control signal, within the full duplex transceiver, based on the at least three voltage measurements.

16. The full duplex transceiver of claim 15, wherein the means for providing the at least one control signal comprise means for providing a balance circuit impedance control signal to a balance circuit, of the full duplex transceiver and having a variable balance circuit impedance, to control a value of the variable balance circuit impedance.

17. The full duplex transceiver of claim 16, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

18. The full duplex transceiver of claim 15, wherein the means for providing the at least one control signal comprise means for providing a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

19. The full duplex transceiver of claim 15, wherein the means for obtaining the at least three voltage measurements comprise means for obtaining a first voltage measurement from a first point between the power amplifier and a balun of the full duplex transceiver.

20. The full duplex transceiver of claim 19, wherein the means for obtaining the at least three voltage measurements comprise means for obtaining a second voltage measurement from a second point between the balun and the antenna.

21. The full duplex transceiver of claim 15, further comprising means for using a machine learning model to determine an output impedance presented to the power amplifier by circuitry between an output of the power amplifier to, and including, the antenna.

22. A non-transitory, processor-readable storage medium comprising processor-readable instructions to cause at least one processor, of a full duplex transceiver, to:
transmit a transmit signal via a power amplifier and a duplexer to an antenna of the full duplex transceiver;
receive, via the antenna and the duplexer, a receive signal;
obtain at least three voltage measurements from respective points between the power amplifier and the antenna; and
provide at least one control signal, within the full duplex transceiver, based on the at least three voltage measurements.

23. The non-transitory, processor-readable storage medium of claim 22, wherein the processor-readable instructions to cause the at least one processor to provide the at least one control signal comprise processor-readable instructions to cause the at least one processor to provide a balance circuit impedance control signal to a balance circuit, of the full duplex transceiver and having a variable balance circuit impedance, to control a value of the variable balance circuit impedance.

24. The non-transitory, processor-readable storage medium of claim 23, wherein the balance circuit impedance control signal is configured to control the value of the variable balance circuit impedance to attempt to match a second impedance, presented to the power amplifier by at least the balance circuit, to a first impedance presented to the power amplifier by at least the antenna.

25. The non-transitory, processor-readable storage medium of claim 22, wherein the processor-readable instructions to cause the at least one processor to provide the at least one control signal comprise processor-readable instructions to cause the at least one processor to provide a tuner control signal to a tuner circuit, of the full duplex transceiver and having a variable tuner impedance, to set a value of the variable tuner impedance to attempt to cause an output impedance, presented to the power amplifier by at least the antenna and the tuner circuit, to match a power amplifier impedance of the power amplifier.

26. The non-transitory, processor-readable storage medium of claim 22, wherein the processor-readable instructions to cause the at least one processor to obtain the at least three voltage measurements comprise processor-readable instructions to cause the at least one processor to obtain a first voltage measurement from a first point between the power amplifier and a balun of the full duplex transceiver.

27. The non-transitory, processor-readable storage medium of claim 26, wherein the processor-readable instructions to cause the at least one processor to obtain the at least three voltage measurements comprise processor-readable instructions to cause the at least one processor to obtain a second voltage measurement from a second point between the balun and the antenna.

28. The non-transitory, processor-readable storage medium of claim 22, further comprising processor-readable instructions to cause the at least one processor to use a machine learning model to determine an output impedance presented to the power amplifier by circuitry between an output of the power amplifier to, and including, the antenna.
